(19) United States
(12) Patent Application Publication
(10) Pub. No.: US 2025/0187768 A1
(43) Pub. Date: Jun. 12, 2025

(54) MULTIFUNCTIONAL SEALING MACHINE

(71) Applicant: UNICCA INC., ABERDEEN, WA (US)

(72) Inventor: Yuzhen Wang, Shaoxing City (CN)

(21) Appl. No.: 19/059,114

(22) Filed: Feb. 20, 2025

(30) Foreign Application Priority Data
Jan. 16, 2025 (CN) 202520106135.X

(51) Int. Cl. B65B 31/04; B65B 51/10

(52) U.S. Cl. CPC B65B 31/048; B65B 51/10

(57) ABSTRACT

Disclosed is a multifunctional sealing machine which includes a base, a cover body and an air extraction mechanism; when the base and the cover body are in a combined state, an air extraction chamber enclosed therebetween is in communication with a first air inlet of the air extraction mechanism in the base, and the base and the cover body cooperate to clamp an object to be air extracted which extends into the chamber; and the machine further includes a connector for external air extraction connection, and the connector is movably connected to the base. The connector for external connection is added to the machine, and when in use, the machine can be interfaced with a bag body to be vacuumized or the like through the chamber or interfaced with an external tank body to be vacuumized or the like through the connector as needed, which increases functionality of the machine.

### TECHNICAL FIELD

The invention belongs to the technical field of sealing devices, and specifically relates to a multifunctional sealing machine.

### BACKGROUND

Sealing machines are common tools in life. For example, air in a bag body is extracted by a sealing machine and a seal thereof is melted by a heating mechanism. A common sealing machine includes a base and a cover body; the cover body is hinged to the base, an end portion of the bag body is placed on the base, the cover body is rotated to be combined with the base to clamp the end portion of the bag body, and an air extraction chamber for vacuumizing is enclosed between the cover body and the base, and an air extraction mechanism in the base, such as an air extraction pump, is started to extract air in the air extraction chamber, and the air in the bag body flows out into the air extraction chamber in synchronization. However, such sealing machines have limited scope of use and can not extract air from tank bodies and other objects. Therefore, improvement is needed.

### SUMMARY

In order to solve at least one of the above technical defects, the invention provides the following technical solution.

The present application document discloses a multifunctional sealing machine which includes a base, a cover body and an air extraction mechanism; when the base and the cover body are in a combined state, an air extraction chamber is formed between the base and the cover body, the air extraction chamber is in communication with a first air inlet of the air extraction mechanism in the base, and the base and the cover body cooperate to clamp an object to be air extracted which extends into the air extraction chamber; the multifunctional sealing machine further includes a connector for external air extraction connection, the connector is movably connected to the base, a cavity channel in communication with an air inlet end of the air extraction mechanism is provided on the base, and a second air inlet of the cavity channel is located at the position where the connector is connected with the base; and the connector is provided with a first air outlet and a third air inlet in communication with an inner channel of the connector, and a position of the connector is adjusted relative to the base so that the first air outlet of the connector corresponds to the second air inlet of the cavity channel so as to be in a communication state or misaligned to disconnect communication.

The connector for external connection is added to the sealing machine of the invention. When in use, the multifunctional sealing machine can be interfaced with a bag body to be vacuumized or the like through the air extraction chamber according to requirements, or interfaced with an external tank body to be vacuumized or the like through the connector, which increases functionality of the sealing machine.

For the cavity channel, for example, the cavity channel is formed in the base or through an external pipe, and the cavity channel is always connected with the first air inlet of the air extraction mechanism. When in use, for example, a position of the connector is adjusted so that the first air outlet of the connector is misaligned with the second air inlet of the cavity channel, in this case, an end portion of the bag body can be clamped by the cover body and the base normally to perform vacuumizing; when the multifunctional sealing machine is interfaced with a tank body or the like to be vacuumized by the connector for vacuumizing, positions of the cover body and the base are adjusted so that the cover body and the base are in the combined state or the channels of the air extraction mechanism and the air extraction chamber are closed, the connector is rotated so that the first air outlet of the connector correspond to the second air inlet of the cavity channel to communicate the first air outlet with the second air inlet, and in this case, the tank body or the like at the connector can be vacuumized by the air extraction mechanism.

Of course, the cavity channel may also be in indirect communication with the first air inlet of the air extraction mechanism. For example, the cavity channel is in communication with the air extraction chamber, and the first air inlet of the air extraction mechanism is also in communication with the air extraction chamber, so that the first air inlet of the air extraction mechanism is synchronously in communication with the cavity channel. When the connected tank body is vacuumized by the connector, the cover body and the base are combined to form the air extraction chamber, and the air extracted from the tank body enters the air extraction chamber through the cavity channel, and is then discharged through the air extraction mechanism.

The position of the connector on the base, such as at an end portion or on a side, may be selected according to requirements.

Further, the connector is pivotally connected at an end face of the end portion of the base and the first air outlet is located at a peripheral wall of the connector; the second air inlet located in the cavity channel is provided at a side wall of a mounting groove at the end face of the end portion of the base for mounting the connector; and the connector is rotated relative to the base so that the first air outlet of the connector corresponds to or is misaligned with the second air inlet of the cavity channel; when in use, the connector can be rotated to realize communication or disconnection between the connector and the cavity channel, which is convenient to use; and the layout of arranging the connector at the end face of the base helps to simplify the structure of the base, and a groove for placing the connector can be formed at the end portion, which avoids redesign of more positions, and is convenient to form and assemble.

Further, the multifunctional sealing machine further includes an elastic adapter; the elastic adapter includes a transverse portion and a longitudinal portion, a channel in the transverse portion is in communication with a channel in the longitudinal portion, an end portion of the longitudinal portion is located in the second air inlet of the cavity channel, the transverse portion is sleeved on a tail end of the connector, and the connector is rotated relative to the elastic adapter so that the first air outlet corresponds to or is misaligned with a channel inlet in the longitudinal portion. Adding the elastic adapters helps improve tightness of the connection and reduce leakage to facilitate vacuumizing.

Further, the connector includes a cylindrical main body and a insertion post located at a tail end of the main body, a diameter of the insertion post is less than a diameter of the main body, a channel in the insertion post is in communication with a channel in the main body, the longitudinal portion in the elastic adapter is sleeved on the insertion post, and the first air outlet port in communication with the channel in the insertion post is arranged at a peripheral wall of the insertion post.

A limiting plate is provided on the main body or the insertion post, a limiting block is provided in the base, and the limiting block is located on a rotation path of the limiting plate to limit a rotation amplitude thereof.

The structure of the connector is designed, the cylindrical main body facilitates connection with the tank body or the like by insertion, and the diameter of the insertion post can be adjusted, such as smaller than the diameter of the main body, so that the insertion post can be easily interfaced with the base for mounting. The cooperation between the limiting plate and the limiting block can synchronously limit the rotation amplitude of the connector, and avoid leakage of the interfacing between the connector and the cavity channel due to excessive rotation.

Further, the second air outlet of the cavity channel is located at a cavity wall of the air extraction chamber to communicate the cavity channel with the air extraction chamber, which helps to simplify the structure.

Further, the multifunctional sealing machine further includes a water storage tank, a slot is provided on the base, and the water storage tank is inserted into the slot; an inlet pipe of the water storage tank protrudes from a bottom surface of the base; the inlet pipe of the water storage tank is located in the air extraction chamber when the cover body is combined with the base; an outlet pipe of the water storage tank is in communication with the first air inlet of the air extraction mechanism, and the air extraction chamber is in communication with the first air inlet of the air extraction mechanism through the water storage tank, so that moisture in the bag body or other items to be vacuumized can remain in the water storage tank to avoid affecting the air extraction mechanism, which integrates the dry-wet separation function to facilitate use.

Further, an outlet pipe head end and an inlet pipe head end of the water storage tank are located at a same surface of a tank body of the water storage tank, and a water discharge port is provided at a tank surface of the water storage tank between the outlet pipe head end and the inlet pipe head end of the water storage tank; a sealing plug is provided at the water discharge port; and an outlet pipe tail end and an inlet pipe tail end both extend into a tank body cavity in the water storage tank, a baffle is provided around the inlet pipe tail end, and the outlet pipe tail end and the inlet pipe tail end extend into the tank body cavity, which can improve water storage capacity of the water storage tank and reduce the number of replacements. Reasonably arranging a position of the water discharge port and positions of the inlet pipe and the outlet pipe can facilitate the forming of a relatively large water discharge port and shorten water discharge time.

Further, a magnetic attraction member is provided on the cover body or the base, and the sealing machine is suspended by magnetic attraction between the magnetic attraction member and the object to be mounted. The sealing machine can be attracted to a refrigerator by the magnetic attraction member, which is convenient for placement.

Further, a placement groove is provided at an upper edge side of a surface of the base facing the cover body, and a cutter is inserted into the placement groove. Therefore, the cutter is added. When necessary, the cutter can be pulled out to cut the bag body or the like.

Further, the connector is slidably connected to the base, and the connector is moved back and forth relative to the base so that the first air outlet of the connector corresponds to or is misaligned with the second air inlet of the cavity channel.

Further, the base includes an upper portion and a lower portion which are connected by insertion; a control board, a battery, a pressure sensor and the air extraction mechanism are provided at a surface of the lower portion facing the upper portion; the cover body is pivotally connected at an edge side of a bottom surface of the lower portion, a recess is provided at a surface of the cover body facing the base, and a first sealing strip is provided around a notch of the recess; a second sealing strip is provided at a surface of the first sealing strip corresponding to the base; in the combined state of the cover body and the base, the first sealing strip abuts against the second sealing strip, a heating mechanism for sealing is provided in a ring mouth surrounded by the second sealing strip, and control keys are provided at a top surface of the upper portion; the heating mechanism, the air extraction mechanism, the battery, the control keys and the pressure sensor are all connected with the control board, and the pressure sensor is configured to detect pressure of the air extraction chamber; and when the pressure exceeds a set pressure, the control board stops action of the air extraction mechanism. The base is a split structure. That is, the base includes the upper portion and the lower portion, which facilitates mounting of functional components such as the battery and the air extraction structure, and facilitates assembly and forming. The pressure sensor can cooperate with the control board to provide overpressure protection, which improves operational stability.

Compared with the prior art, the invention has the following beneficial effects.

The connector for external connection is added to the sealing machine of the invention, and the multifunctional sealing machine can be interfaced with a bag body or a tank body according to requirements, which increases functionality of the sealing machine.

### BRIEF DESCRIPTION OF THE DRAWINGS

In order to illustrate the technical solution of the embodiments of the invention more clearly, the accompanying drawings required for the description of the embodiments will be briefly introduced below. Apparently, the accompanying drawings in the following description are merely some rather than all embodiments of the invention, and a person of ordinary skill in the art may still derive other drawings from these accompanying drawings without creative efforts.

FIG. 1 is a schematic structural diagram of a sealing machine according to Embodiment 1;

FIG. 2 is a schematic structural diagram of the sealing machine with a base removed according to Embodiment 1;

FIG. 3 is a schematic cross-sectional structural diagram of the sealing machine according to Embodiment 1;

FIG. 4 is a schematic diagram of a connection structure of a connector and an elastic adapter in Embodiment 1;

FIG. 5 is a schematic diagram of a separation structure of a water storage tank and the base in Embodiment 1;

FIG. 6 is a schematic diagram of a separation structure of the water storage tank and the base in Embodiment 1;

FIG. 7 is a schematic cross-sectional structural diagram of the sealing machine according to Embodiment 1; and

FIG. 8 is a schematic structural diagram of a cover plate and the base in an unfolded state according to Embodiment 1.

Reference numerals in the drawings: 1. base; 2. cover body; 3. connector; 4. water storage tank; 5. limiting plate; 6. air extraction mechanism; 7. battery; 8. air extraction chamber; 9. control board; 10. cutter; 11. control key; 12. pressure sensor; 13. elastic adapter; 14. heating mechanism; 15. first sealing strip; 16. second sealing strip; 17. support leg; 18. pressing strip; 19. magnetic attraction member; 20. cavity channel; 21. buckle; 31. main body; 32. insertion post; 33. first air outlet; 34. third air inlet; 41. sealing plug; 42. inlet pipe; 43. outlet pipe; 44. baffle; 45. inlet pipe tail end; 46. water discharge port; 61. first air inlet; 100. limiting block; 101. slot; 102. upper portion; 103. lower portion; 104. lock seat; 105. air hole; 106. insertion hole; 107. mounting groove; 108. placement groove; 131. longitudinal portion; 132. transverse portion; 201. second air inlet; 202. second air outlet; and 431. outlet tube tail end.

### DESCRIPTION OF THE EMBODIMENTS

The invention will be further described below with reference to the accompanying drawings and specific embodiments.

### EMBODIMENTS

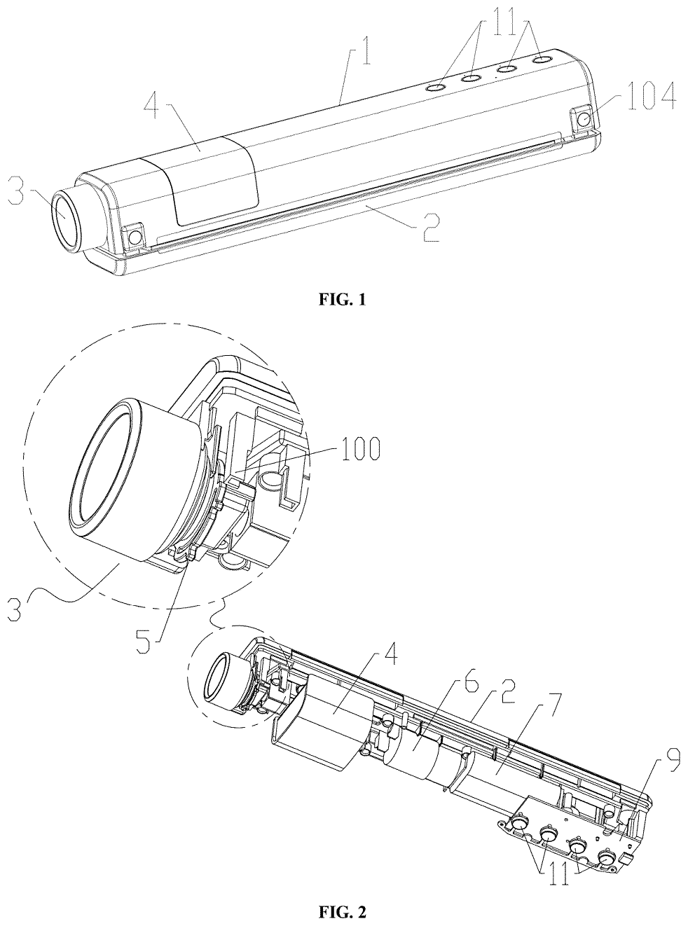

As shown in FIG. 1, the multifunctional sealing machine in the present embodiment includes a base 1, a cover body 2 and an air extraction mechanism 6, where the base 1 is connected with the cover body 2, and in the configuration as shown in FIG. 8, an edge side of the cover body 2 is hinged at an edge side of a bottom surface of the base 1, and when in use, as the cover body 2 is rotated from an unfolded state as shown in FIG. 8 toward the bottom surface of the base 1 to be combined with the base 1. Of course, it is also possible that the base 1 and the cover body 2 are independent, and when in use, the cover body 2 is fixed at the bottom surface of the base 1 by a buckle 21 or the like to be combined; and it is also possible that the cover body 2 and the base 1 are slidably connected in a thickness direction of the base 1, and the cover body 2 is moved toward the bottom surface of the base 1 to be combined.

In a combined state, a chamber (i.e., air extraction chamber 8) is enclosed between the cover body 2 and the bottom surface of the base 1. In order to improve sealing performance, a first sealing strip 15 and a second sealing strip 16 may be correspondingly mounted on surfaces of the cover body 2 and the base 1 facing each other. For example, a ring body formed of an elastic material such as rubber or sponge may be used as the first sealing strip 15 and the second sealing strip 16. The second sealing strip 16 is fixed on the bottom surface of the base 1, and the first sealing strip 15 is fixed on the corresponding surface of the cover body 2. When the cover body 2 and the base 1 are in the combined state, the first sealing strip 15 and the second sealing strip 16 abut against each other and cooperate with the bottom surface of the base 1 in the ring body and the corresponding surface of the cover body 2 to form the air extraction chamber 8. At the same time, the cover body 2 and the base body 1 in the combined state clamp an end portion of a bag body extending into the air extraction chamber 8.

The air extraction mechanism 6, such as a common air extraction pump, is arranged in the base 1, and a first air inlet 61 of the air extraction mechanism 6 is in communication with the air extraction chamber 8 to extract air in the air extraction chamber 8 by the air extraction chamber 8. The air extraction mechanism 6 is in communication with the air extraction chamber 8 through a flow channel formed on the base 1 or an external pipe, or through a water storage tank 4 as described below.

In the present embodiment, a connector 3 for external air extraction connection is added to the sealing machine, the connector 3 is inserted into an external tank body, or the connector 3 extends into a bag body, a tank body, a cylinder chamber or the like to be air extracted; the configuration of the connector 3 may be according to requirements, such as a common cylindrical shape. A channel is formed in the connector 3 for gas, liquid or the like to pass through, and the channel is in communication with a third air inlet 34 and a first air outlet 33 on the connector 3. For example, the third air inlet 34 is located at a head end of the connector 3, and the first air outlet 33 is located at a tail end of the connector 3. The connector 3 is movably connected to the base 1, a cavity channel 20 is provided on the base 1, and the cavity channel 20 is in communication with an air inlet end of the air extraction mechanism 6; a second air inlet 201 of the cavity channel 20 is located at a position where the connector 3 is connected with the base 1, and the position of the connector 3 can be adjusted relative to the base 1. For example, the first air outlet 33 of the connector 3 corresponds to the second air inlet 201 of the cavity channel 20, that is, is in a communication state. The tank body connected with the connector 3 can be air extracted by the air extraction mechanism 6. Alternatively, the first air outlet 33 of the connector 3 and the second air inlet 201 of the cavity channel 20 are misaligned, i.e. disconnected, without affecting air extraction from the air extraction chamber 8 by the air extraction mechanism 6.

For a specific connection structure of the connector 3 and the base 1, the connector 3 is pivotally connected to the base 1, specifically as shown in FIGS. 1, 2, 3 and 4; a mounting groove 107 is formed at an end face of an end portion of the base 1, and a tail end of the connector 3 is located in the mounting groove and can be rotated relative to the base 1. For example, the connector 3 can be rotated left and right with an axial centerline of the base 1 as a rotation centerline when in use. The first air outlet 33 of the connector 3 is located at a peripheral wall of the tail end of the connector 3, the second air inlet 201 of the cavity channel 20 is located at a side wall of the mounting groove 107, the second air inlet 201 is located on a moving path of the first air outlet 33, the connector is rotated to cause the first air outlet 33 to be opposite to the second air inlet 201 so that they are in a communication state, and the connector is rotated to misalign the first air outlet 33 with the second air inlet 201 to disconnect the communication.

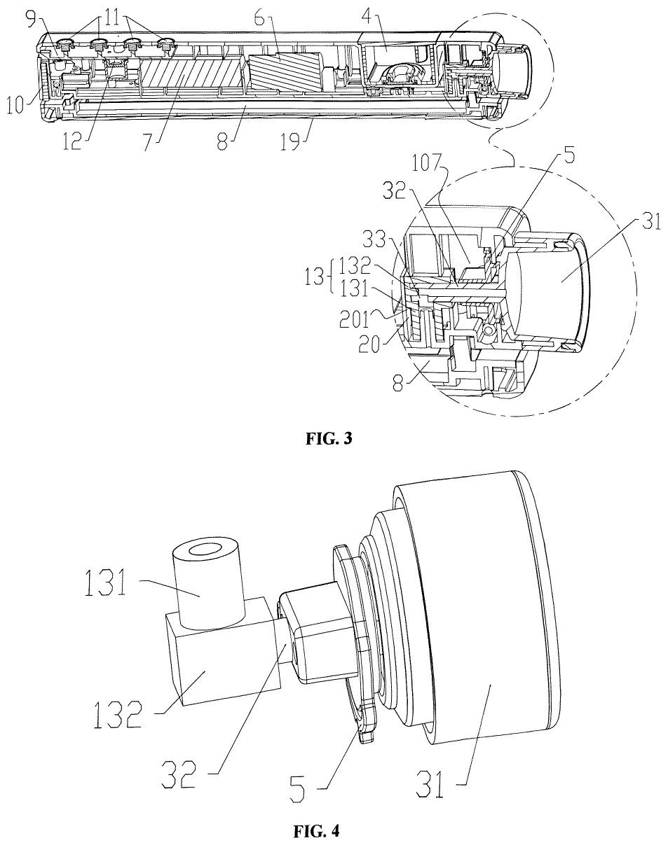

In order to improve tightness, an elastic adapter 13, that is, an adapter 13 formed of an elastic material, such as a rubber material, may also be added. The elastic adapter 13 includes a transverse portion 132 and a longitudinal portion 131 which are connected in an L-shape as shown in FIG. 4. Of course, other configurations can be selected, and a channel in the transverse portion 132 is in communication with a channel in the longitudinal portion 131. As shown in FIG. 3, an end portion of the longitudinal portion 131 is located in the second air inlet 201 of the cavity channel 20, and the transverse portion 132 is sleeved on the tail end of the connector 3 to help improve the tightness under elastic cladding. When in use, the connector 3 is rotated relative to the elastic adapter 13 to correspond the first air outlet 33 to an inlet of the channel in the longitudinal portion 131 and to the second air inlet 201 of the cavity channel 20 in synchronization, or to misalign the first air outlet 33 with the inlet of the channel in the longitudinal portion 131 and with the second air inlet 201 of the cavity channel 20 in synchronization.

In order to facilitate mounting, the connector 3 in the present embodiment adopts a configuration as shown in FIG. 4, and specifically includes a cylindrical main body 31 and a post located at a tail end of the main body, namely an insertion post 32, a diameter of the insertion post 32 is smaller than a diameter of the main body 31, a channel in the insertion post 32 is in communication with a channel in the main body 31, the longitudinal portion in the elastic adapter 13 is sleeved on the insertion post 32, the first air outlet 33 in communication with the channel in the insertion post 32 is formed at a peripheral wall of a tail end of the insertion post 32, and the diameter of the insertion post 32 in this configuration is small, which avoids forming the mounting groove 107 with a relative large diameter at the base 1, thus facilitating the design of the base configuration and interfacing with the base 1. When in use, the sealing machine is sleeved on a mouth of the tank body by the main body, and then air is extracted by the air extraction mechanism 6. However, the diameter of the main body may be reduced, and when in use, the sealing machine is inserted into the mouth of the tank body or into cavities of other bag bodies to be vacuumized. A sealing ring may be mounted at an end surface of the main body 31, which helps improve the tightness when being interfaced with the tank body or the like. Of course, other configurations may be chosen for the connector, such as L-shape, stepped shaft shape, single-diameter cylinder, etc. A suitable connector configuration may be selected according to an inlet configuration of the object to be air extracted, without limitation.

In order to limit a rotation amplitude of the connector, a limiting plate 100 is also added in the present embodiment, as shown in FIGS. 3 and 4, the limiting plate 5 is sleeved on the insertion post 32 through a hole in the middle, the limiting plate 5 is fixed to an end face of the tail end of the main body 31 by screws or the like, a limiting block 100 is formed at a groove wall of the mounting groove of the base 1, the limiting block 100 is located on a rotation path on an edge side of part of the limiting plate 5. For example, two limiting blocks 100 are arranged at intervals, when the connector 3 is rotated, the limiting plates rotate synchronously. An upper left side of the limiting plate 5 abuts against one limiting block 100 to limit continuous rotation thereof, and in this case, the first air outlet 33 corresponds to the second air inlet 201 of the cavity channel 20. When the connector 3 is rotated back, an upper right side of the timing plate 5 abuts against the other limiting block 100 to limit continuous rotation thereof, and in this case, the first air outlet 33 is misaligned with the second air inlet of the cavity channel 20, and the two limiting blocks 100 limit the rotation amplitude of the connector 3, which helps to rotate the connector 3 to change a connection state of the first air outlet 33 and the cavity channel 20. In addition, the limiting plate 5 may have a length greater than a diameter of a notch of the mounting groove 107 at an end surface thereof or a diameter of a groove section of the mounting groove 107 to restrict outward pulling of the connector 3 relative to the base 1.

The position of the connector 3 may be arranged at a position such as a side surface of the base 1 according to requirements, and may be selected according to requirements.

Of course, it is also possible to adopt a structure in which the connector 3 is slidably connected to the base 1. For example, the connector 3 is slidably fitted to the base 1 along a length direction of the base 1, the second air inlet 201 of the cavity channel 20 is also arranged at the side wall of the mounting groove 107, the first air outlet 33 is formed at the peripheral wall of the tail end of the connector 3, and the connector 33 is slid forward and backward relative to the base 1, so that the first air outlet 33 and the second air inlet 201 are opposite to each other to communicate or misaligned to disconnect communication, depending on requirements.

For the cavity channel 20, the cavity channel 20 is formed by an external hose or a hard pipe or the like, or the channel, flow channel or the like formed in the base 1 is used as the cavity channel 20, or both are combined to form the cavity channel 20, and the cavity channel 20 may be in direct or indirect communication with the first air inlet 61 of the air extraction mechanism 6. For example, an end outlet of the cavity channel 20 is direct connected with (i.e., in direct communication with) the first air inlet 61 of the air extraction mechanism 6.

In the present embodiment, the indirect communication is shown as an example. As shown in FIGS. 1, 2, 3 and 4, the cavity channel 20 is formed in the base 1, and the second air outlet 202 of the cavity channel 20 is located at a cavity wall of the air extraction chamber 8 to communicate with the air extraction chamber 8. Specifically, the second air outlet 202 of the cavity channel 20 extends to the bottom surface of the base 1 (synchronously located in an ring mouth of the second sealing strip 16). The air extraction chamber 8 is synchronously in communication with the first air inlet of the air extraction mechanism 6, so that the cavity channel 20 is also in communication with the first air inlet 61 of the air extraction mechanism 6. When air is extracted through the connector 3, the cover body and the base 1 need to be in the combined state, and when air is extracted from the bag body or the like through the air extraction chamber 8, the first air outlet 33 of the connector and the second air inlet 201 of the cavity channel 20 need to be in a misaligned state.

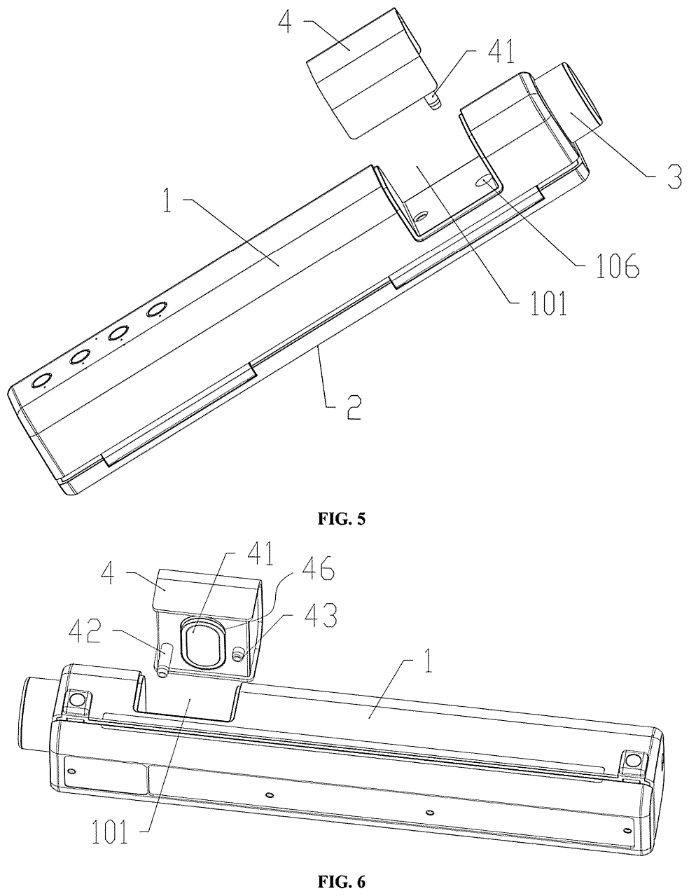

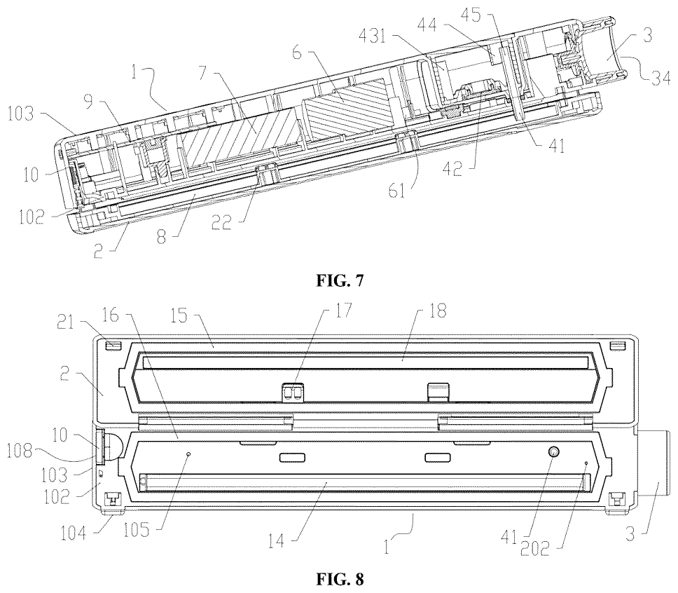

Considering that some of bag bodies contain water, in order to avoid affecting the air extraction by the air extraction mechanism 6, a water storage tank 4 is added in the present embodiment, and as shown in FIGS. 1, 2, 3, 5, 6 and 7, a slot 101 is formed at a top surface of the base 1, the water storage tank 4 is mounted at the slot 101 by insertion, and the water storage tank 4 may be pulled out as required to discharge water. An insertion hole 106 is formed at a slot wall of the slot 101, and when the water storage tank 4 is mounted, an inlet pipe 41 on a tank body thereof is inserted into the insertion hole 106 and protrudes from the bottom surface of the base 1 and is also located in the ring mouth of the second sealing strip 16, and when the cover body 2 is combined with the base 1, the inlet pipe 41 is located in the air extraction chamber 8. An outlet pipe 43 (e.g., taking a hole as the outlet pipe, or an outwardly convex pipe body as the outlet pipe) on the tank body in the water storage tank 4 is in communication with the first air inlet of the air extraction mechanism 6, such as through a hose or the like, and the air extraction chamber 8 is in communication with the first air inlet of the air extraction mechanism 6 through the water storage tank 4. When in use, moisture in the bag bodies to be evacuated or the like can be left in the water storage tank 4 to avoid affecting the air extraction mechanism 6, which integrates the dry-wet separation function.

In order to improve the dry-wet separation function, that is, to facilitate water discharge, the structure of the water storage tank 4 is designed in the present embodiment. Specifically, a head end of the outlet pipe 43 and a head end of the inlet pipe 41 are located at a same surface of the tank body of the water storage tank 4, and a water discharge port 46 is formed at a tank surface therebetween, and a sealing plug 42 is provided at the water discharge port 46 for sealing. Both an outlet pipe tail end 431 and an inlet pipe tail end 45 extend into a tank body cavity in the water storage tank 4, and are surrounded by a baffle 44 at the tail end of the inlet pipe 41, the baffle 44 is connected to a tank wall of the water storage tank 4, and the baffle 44 limits the splashing of water. The outlet pipe tail end 43 and the inlet pipe tail end 45 extend into the tank cavity, and the tail end of the outlet pipe 43 has a height of a predetermined size relative to the tank wall therebelow to prevent water discharged from the inlet pipe tail end 45 from directly flowing into the outlet pipe 43. This design can also improve water storage capacity of the water storage tank 4. When water discharge is required, the water storage tank 4 can be directly pulled out, and the sealing plug 42 can be pulled out for water discharge.

In order to facilitate storage and placement of the sealing machine, a magnetic attraction member 19 is added in the present embodiment. As shown in FIG. 3, the magnetic attraction member 19 is tabled and fixed at a bottom surface of the cover body 2, and can of course also be fixed by screws or the like, and the magnetic attraction member 19 can be selected as a bar magnet as shown in FIG. 3, and can of course also be composed of a plurality of independent blocks, without limitation to configuration thereof and depending on requirements. A magnetic force of the magnetic attraction member 19 is selected, and in the present embodiment, the sealing machine can be fixed to a refrigerator door by the magnetic attraction member 19 in a suspended state, without the need of a special place for mounting. Of course, the magnetic attraction 19 may alternatively be mounted on the base 1, depending on requirements.

A cutter can also be added. As shown in FIGS. 3 and 8, a recess (i.e., a placement groove 108) is formed at an upper edge side of a surface of the base 1 facing the cover body 2, and the cutter 10 is inserted into the placement groove 108. The type of the cutter 10 can be selected according to requirements, such as a blade, a blade to be gripped or the like, and the cutter 10 can be pulled out to cut the bag body or the like when necessary.

In order to facilitate locking of the cover body, a locking mechanism can also be added. For example, the locking mechanism includes a lock seat 104 and a buckle 21, the buckle 21 is mounted on the cover body 2, and the lock seat 104 is elastically connected to a side surface of the base 1 by a spring. When the cover body 2 is combined with the base 1, the buckle 21 is inserted into a slot on the lock seat 104 which matches with the buckle 21, and then the cover body 2 is locked at the position; and the lock seat 104 can be pressed to separate the buckle 21 from the slot, and in this case, the cover body 2 can be rotated relative to the base 1.

In order to facilitate control and use, the sealing machine of the invention further includes a control board 9, a battery 7, a pressure sensor 12 and the like. In order to facilitate mounting, in the present embodiment, the base 1 is of a split assembly type. As shown in FIGS. 7, 3 and 2, the base 1 includes an upper portion 102 and a lower portion 103 which are connected by insertion. For example, the lower portion 103 is inserted into a groove cavity of the upper portion 102; the control board 9, the battery 7, the pressure sensor and the air extraction mechanism 6 are mounted at a surface of the lower portion 103 facing the upper portion 102; the pressure sensor 12 is mounted on the control board 9, and an air hole 105 for detecting pressure by the pressure sensor extends to the bottom face of the base 1 and is located in the ring mouth of the second sealing strip 16 to detect the magnitude of the pressure in the air extraction chamber 8. The cavity channel 20 interfaced with the connector 3 is formed at the lower portion 103.

The cover body 2 is pivotally connected at an edge side of a bottom surface of the lower portion 103, a recess is formed at a surface of the cover body 2 facing the base 1 and the first sealing strip 15 is arranged around a notch of the recess. The recess is added to increase water output, and liquid extracted from the bag body is prestored, and then is extracted into the water storage tank 4 through an air inlet pipe.

A heating mechanism 14 for sealing is located at the bottom surface of the base 1 in the ring mouth surrounded by the second sealing strip 16, and a pressing strip 18 formed of an elastic material can be added at a corresponding position on the cover body 2. When the cover body and the machine base are combined, the end portion of the bag body is clamped between the pressing strip 18 and the heating mechanism 14, and the heating mechanism heats to melt the bag body for sealing. The heating mechanism can be selected from the market according to demand, such as common heating wire type. A support leg 17 can also be added. The support leg 17 is fixed to the surface of the cover body 2 facing the base, and when the cover body is combined with the base, the support leg 17 abuts against the bottom surface of the base, and the size of the support leg can be predetermined to limit a combination degree of the cover body and the base to avoid excessive clamping of the end portion of the bag body and slowing down vacuumizing speed, etc.

Control keys 11 are mounted on a top surface of the upper portion 102; and the heating mechanism 14, the air attraction mechanism 6, the battery 7, the control keys 11 and the pressure sensor 12 are all connected with the control board 9. A plurality of control keys 11 as shown in FIGS. 1 and 3 can correspondingly execute a dry extraction mode, a wet extraction mode, air extraction by the air extraction chamber 8, air extraction by the connector 3, and the like, and the air extraction time in the wet extraction mode is longer than the air extraction time in the dry extraction mode.

When in use, the pressure sensor is configured to detect pressure of the air extraction chamber, and when the pressure exceeds a set pressure, the control board stops action of the air extraction mechanism to play the role of overpressure protection. At the time of assembly, each functional mechanism may be mounted at the upper portion in advance, and then the upper portion is inserted into the lower portion to form the base 1.

What is claimed is:

1. A multifunctional sealing machine, comprising a base, a cover body and an air extraction mechanism, when the base and the cover body being in a combined state, an air extraction chamber being formed between the base and the cover body, the air extraction chamber being in communication with a first air inlet of the air extraction mechanism in the base, and the base and the cover body cooperating to clamp an object to be air extracted which extends into the air extraction chamber, wherein the multifunctional sealing machine further comprises a connector for external air extraction connection, the connector is movably connected to the base, a cavity channel in communication with an air inlet end of the air extraction mechanism is provided on the base, and a second air inlet of the cavity channel is located at the position where the connector is connected with the base; and the connector is provided with a first air outlet and a third air inlet in communication with an inner channel of the connector, and a position of the connector is adjusted relative to the base so that the first air outlet of the connector corresponds to the second air inlet of the cavity channel so as to be in a communication state or misaligned to disconnect communication.

2. The multifunctional sealing machine according to claim 1, wherein the connector is pivotally connected at an end face of an end portion of the base and the first air outlet is located at a peripheral wall of the connector; the second air inlet located in the cavity channel is provided at a side wall of a mounting groove at the end face of the end portion of the base for mounting the connector; and the connector is rotated relative to the base so that the first air outlet of the connector corresponds to or is misaligned with the second air inlet of the cavity channel.

3. The multifunctional sealing machine according to claim 2, wherein the multifunctional sealing machine further comprises an elastic adapter, the elastic adapter comprises a transverse portion and a longitudinal portion, a channel in the transverse portion is in communication with a channel in the longitudinal portion, an end portion of the longitudinal portion is located in the second air inlet of the cavity channel, the transverse portion is sleeved on a tail end of the connector, and the connector is rotated relative to the elastic adapter so that the first air outlet corresponds to or is misaligned with a channel inlet in the longitudinal portion.

4. The multifunctional sealing machine according to claim 3, wherein the connector comprises a cylindrical main body and a insertion post located at a tail end of the main body, a diameter of the insertion post is less than a diameter of the main body, a channel in the insertion post is in communication with a channel in the main body, the longitudinal portion in the elastic adapter is sleeved on the insertion post, and the first air outlet port in communication with the channel in the insertion post is arranged at a peripheral wall of the insertion post; and
a limiting plate is provided on the main body or the insertion post, a limiting block is provided in the base, and the limiting block is located on a rotation path of the limiting plate to limit a rotation amplitude thereof.

5. The multifunctional sealing machine according to claim 1, wherein the second air outlet of the cavity channel is located at a cavity wall of the air extraction chamber to communicate the cavity channel with the air extraction chamber.

6. The multifunctional sealing machine according to claim 1, wherein the multifunctional sealing machine further comprises a water storage tank, a slot is provided on the base, and the water storage tank is inserted into the slot; an inlet pipe of the water storage tank protrudes from a bottom surface of the base; the inlet pipe of the water storage tank is located in the air extraction chamber when the cover body is combined with the base; and an outlet pipe of the water storage tank is in communication with the first air inlet of the air extraction mechanism.

7. The multifunctional sealing machine according to claim 6, wherein an outlet pipe head end and an inlet pipe head end of the water storage tank are located at a same surface of a tank body of the water storage tank, and a water discharge port is provided at a tank surface of the water storage tank between the outlet pipe head end and the inlet pipe head end of the water storage tank; a sealing plug is provided at the water discharge port; and an outlet pipe tail end and an inlet pipe tail end both extend into a tank body cavity in the water storage tank, and a baffle is provided around the inlet pipe tail end.

8. The multifunctional sealing machine according to claim 1, wherein a magnetic attraction member is provided on the cover body or the base, and the sealing machine is suspended by magnetic attraction between the magnetic attraction member and the object to be mounted.

9. The multifunctional sealing machine according to claim 1, wherein a placement groove is provided at an upper edge side of a surface of the base facing the cover body, and a cutter is inserted into the placement groove.

10. The multifunctional sealing machine according to claim 1, wherein the connector is slidably connected to the base, and the connector is moved back and forth relative to the base so that the first air outlet of the connector corresponds to or is misaligned with the second air inlet of the cavity channel.

11. The multifunctional sealing machine according to claim 1, wherein the base comprises an upper portion and a lower portion which are connected by insertion; a control board, a battery, a pressure sensor and the air extraction mechanism are provided at a surface of the lower portion facing the upper portion; the cover body is pivotally connected at an edge side of a bottom surface of the lower portion, a recess is provided at a surface of the cover body facing the base, and a first sealing strip is provided around a notch of the recess; a second sealing strip is provided at a surface of the first sealing strip corresponding to the base; in the combined state of the cover body and the base, the first sealing strip abuts against the second sealing strip, a heating mechanism for sealing is provided in a ring mouth surrounded by the second sealing strip, and control keys are provided at a top surface of the upper portion; the heating mechanism, the air extraction mechanism, the battery, the control keys and the pressure sensor are all connected with the control board, and the pressure sensor is configured to detect pressure of the air extraction chamber; and when the pressure exceeds a set pressure, the control board stops action of the air extraction mechanism.
